(19) United States
(12) Patent Application Publication
(10) Pub. No.: US 2016/0164406 A1
(43) Pub. Date: Jun. 9, 2016

(54) VOLTAGE PROTECTING CIRCUIT

(71) Applicants: HONG FU JIN PRECISION INDUSTRY (ShenZhen) CO., LTD, Shenzhen (CN); HON HAI PRECISION INDUSTRY CO., LTD., New Taipei (TW)

(72) Inventor: KE-YOU HU, Shenzhen (CN)

(21) Appl. No.: 14/587,840

(22) Filed: Dec. 31, 2014

(30) Foreign Application Priority Data
Dec. 9, 2014 (CN) 201410744972.1

(51) Int. Cl. H02M 3/156

(52) U.S. Cl. CPC H02M 3/156

(57) ABSTRACT

Voltage protecting circuit includes a sensing unit coupled to a power adaptor, a control circuit board for controlling the power adaptor, and a switching unit coupled to the sensing unit and the control circuit board. The sensing unit senses a current voltage of the power adaptor; the control circuit board receives the current voltage of the power adaptor when the switching module is switched on. The control circuit board controls the power adaptor to supply a power voltage when the current voltage of the power adaptor is less than a reference voltage. When the sensing unit receives the power voltage, the switching unit is switched off for preventing the power voltage from flowing into the control circuit board.

### FIELD

The subject matter herein generally relates to a voltage protecting circuit for protecting a control circuit board that is configured to control a power adaptor.

### BACKGROUND

A power control circuit board can be used to control a power adapter to output a power voltage or to be in a sleep mode. When the power voltage flows into the power control circuit board, the power control circuit board can be operated normally.

### BRIEF DESCRIPTION OF THE DRAWINGS

Implementations of the present technology will now be described, by way of example only, with reference to the attached figures.

FIG. 1 is a block diagram of an embodiment of a voltage protecting circuit.

FIG. 2 is a circuit diagram of an embodiment of the voltage protecting circuit of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

The present disclosure is described in relation to a voltage protecting circuit. The voltage protecting circuit includes a sensing unit coupled to a power adaptor, a control circuit board for controlling the power adaptor, and a switching unit coupled to the sensing unit and the control circuit board. The sensing unit senses a current voltage of the power adaptor; the control circuit board receives the current voltage of the power adaptor when the switching module is switched on. The control circuit board controls the power adaptor to supply a power voltage when the current voltage of the power adaptor is less than a reference voltage. When the sensing unit receives the power voltage, the switching unit is switched off for preventing the power voltage from flowing into the control circuit board.

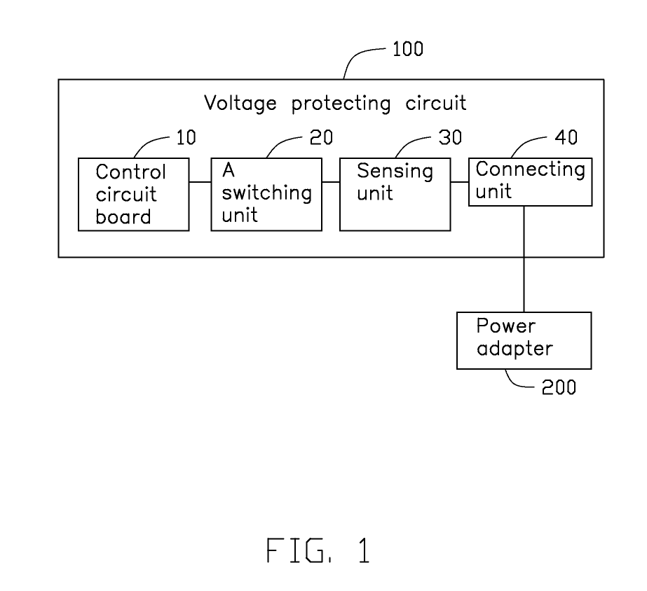

FIG. 1 illustrates an embodiment of a voltage protecting circuit 100 configured to connect a power adapter 200. The voltage protecting circuit 100 comprises a control circuit board 10, a switching unit 20 coupled to the control circuit board 10, a sensing unit 30 coupled to the switching unit 20, and a connecting unit 40 coupled to the sensing unit 30. The voltage protecting circuit 100 is connected to the power adapter 200 via the connecting unit 40.

The control circuit board 10 is configured to control the power adapter 200 for outputting a power voltage or to be in sleep mode.

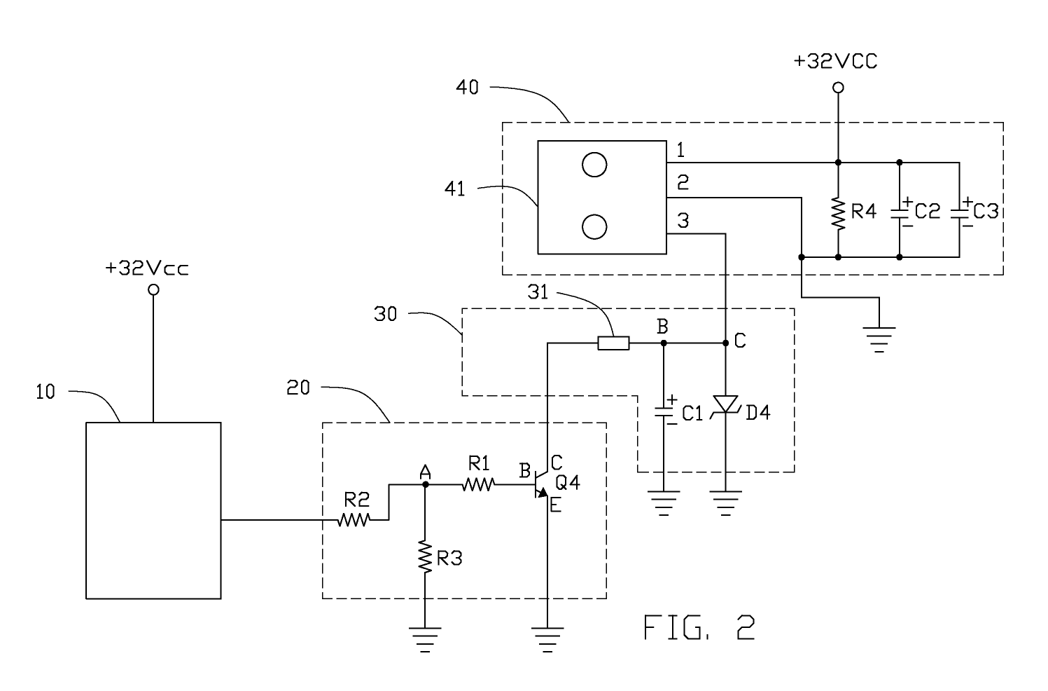

Referring to FIG. 2, the switching unit 20 can comprise a triode Q4, a first resistor R1, a second resistor R2, and a third resistor R3. A base of the triode Q4 is coupled to the first resistor R1, a collector of the triode Q4 is coupled to the sensing unit 30, and an emitter of the triode Q4 is grounded. When a voltage of the base of the triode Q4 is greater than a voltage of the collector of the triode Q4, the triode is switched on, and when the voltage of the base of the triode Q4 is greater than the voltage of the collector of the triode Q4, the triode is switched off. A first terminal of the second resistor R2 is coupled to the control circuit board 10, and a second terminal of the second resistor R2 is coupled to the third resistor R3. A first terminal of the third resistor R3 is coupled to the first resistor R1 and the second resistor R2 via a first node A, and a second terminal of the third resistor R3 is grounded. In at least one embodiment, the resistance of the first resistor R1 is about 0 Ohm, and the resistance of the second resistor R2 is substantially equal to the resistance of the third resistor R3.

The sensing unit 30 comprises a sensor 31, a first capacitor C1 and a voltage-regulator diode D4. A first terminal of the sensor 31 is coupled to the collector of the triode Q4, a second terminal of the sensor 31 is coupled to a positive pole of the first capacitor C1 via a second node B. A negative pole of the first capacitor C1 is grounded. A first terminal of the voltage-regulator diode D4 is coupled to the sensor 31 via a third node C, and a second terminal of the voltage-regulator diode D4 is grounded.

The connecting unit 40 can comprise a connector 41, a fourth resistor R4, a second capacitor C2 and a third capacitor C3. The connector 41 can comprise a first pin 1, a second pin 2, and a third pin 3. The first pin 1 is coupled to the power adaptor 200. The second pin 2 is grounded. The third pin 3 is coupled to the voltage-regulator diode D4 via the third node C. A first terminal of the fourth resistor R4 is coupled to the power adaptor 200, and a second terminal of the fourth resistor R4. A positive pole of the second capacitor C2 is coupled to the power adaptor 200, and a negative pole of the second capacitor C2 is grounded. A positive pole of the third capacitor C3 is coupled to the power adaptor 200, and a negative pole of the third capacitor C3 is grounded.

In use, the voltage of the base of the triode Q4 is greater than a voltage of the collector of the triode Q4, and the triode is switched on. The control circuit board 10 can obtain a current voltage of the power adaptor 200 via the sensor 31. When the control circuit board 10 determines that the current voltage of the power adaptor 200 is less than the reference voltage, the control circuit board 10 controls the power adaptor 200 to be in sleep mode. When the control circuit board 10 determines that the current voltage of the power adaptor 200 is greater than a reference voltage, the control circuit board 10 controls the power adaptor 200 to supply a power voltage. When the power voltage supplied by the power adaptor 200 flows through the sensing unit 30 to the collector of the triode Q4 via the third pin 3, the triode Q4 is switched off, because the voltage of the base of the triode Q4 is greater than the voltage of the collector of the triode Q4. Therefore, the power voltage supplied by the power adaptor 200 cannot flow into the control circuit board 10 to destroy the control circuit board 10

The embodiments shown and described above are only examples. Many details are often found in the art such as the other features of a control circuit board.

Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A voltage protecting circuit comprising:
a sensing unit coupled to a power adaptor;
a control circuit board configured to control the power adaptor; and
a switching unit coupled to the sensing unit and the control circuit board;
wherein the sensing unit is configured to sense a current voltage of the power adaptor, the control circuit board is configured to receive the current voltage of the power adaptor when the switching module is switched on;
wherein the control circuit board is configured to control the power adaptor to supply a power voltage when the current voltage of the power adaptor is less than a reference voltage, and the switching unit is switched off for preventing the power voltage from flowing into the control circuit board, when the sensing unit receives the power voltage.

2. The voltage protecting circuit of claim 1, wherein the switching unit further comprises a triode, a base of the triode is coupled to the control circuit board, a collector of the triode is coupled to the sensing unit, and an emitter of the triode is grounded.

3. The voltage protecting circuit of claim 2, wherein the switching unit further comprises a first resistor, and the base of the triode is coupled to the control circuit board via the first resistor.

4. The voltage protecting circuit of claim 3, wherein the switching unit further comprises a second resistor, a first terminal of the second resistor is coupled to the control circuit board, and a second terminal of the second resistor is coupled to the first resistor.

5. The voltage protecting circuit of claim 4, wherein the switching unit further comprises a third resistor, and the first resistor is grounded and is coupled to the first resistor and the second resistor via a first node.

6. The voltage protecting circuit of claim 5, wherein a resistance of the second resistor is equal to a resistance of the third resistor.

7. The voltage protecting circuit of claim 1, wherein the sensing unit comprises a capacitor and a sensor configured to sense the current voltage of the power adaptor, a first terminal of the capacitor is coupled to the sensor via a second node, and a second terminal of the capacitor is grounded.

8. The voltage protecting circuit of claim 7, further comprising a connector coupled to the sensor, wherein the connector is configured to connect the power adaptor for allowing the sensor to sense the current voltage of the power adaptor.

9. The voltage protecting circuit of claim 8, wherein the sensing unit further comprises a voltage-regulator diode, a first terminal of the voltage-regulator diode is coupled to the sensor and the connector, and a second terminal of the voltage-regulator diode is grounded.

10. A voltage protecting circuit comprising:
a sensing unit coupled to a power adaptor;
a control circuit board configured to control the power adaptor; and
a switching unit coupled to the sensing unit and the control circuit board and the sensing unit;
wherein the control circuit board is configured to control the power adaptor to supply a power voltage or be in a sleep mode when the switching unit is switched on, and when the sensing unit receives the power voltage, the switching unit is switched off for preventing the power voltage from flowing into the control circuit board.

11. The voltage protecting circuit of claim 10, wherein the switching unit further comprises a triode, a base of the triode is coupled to the control circuit board, a collector of the triode is coupled to the sensing unit, and an emitter of the triode is grounded.

12. The voltage protecting circuit of claim 11, wherein the switching unit further comprises a first resistor, and the base of the triode is coupled to the control circuit board via the first resistor.

13. The voltage protecting circuit of claim 12, wherein the switching unit further comprises a second resistor, a first terminal of the second resistor is coupled to the control circuit board, and a second terminal of the second resistor is coupled to the first resistor.

14. The voltage protecting circuit of claim 13, wherein the switching unit further comprises a third resistor, and the first resistor is grounded and is coupled to the first resistor and the second resistor via a first node.

15. The voltage protecting circuit of claim 14, wherein a resistance of the second resistor is equal to a resistance of the third resistor.

16. The voltage protecting circuit of claim 10, wherein the sensing unit comprises a capacitor and a sensor configured to sense the current voltage of the power adaptor, a first terminal of the capacitor is coupled to the sensor via a second node, and a second terminal of the capacitor is grounded.

17. The voltage protecting circuit of claim 16, further comprising a connector coupled to the sensor, wherein the connector is configured to connect the power adaptor for allowing the sensor to sense the current voltage of the power adaptor.

18. The voltage protecting circuit of claim 17, wherein the sensing unit further comprises a voltage-regulator diode, a first terminal of the voltage-regulator diode is coupled to the sensor and the connector, and a second terminal of the voltage-regulator diode is grounded.
